(19) United States
(12) Patent Application Publication
(10) Pub. No.: US 2025/0070611 A1
(43) Pub. Date: Feb. 27, 2025

(54) MOTOR AND PUMP WITH SUCH A MOTOR

(71) Applicant: E.G.O. Elektro-Gerätebau GmbH, Oberderdingen (DE)

(72) Inventors: Tobias Albert, Kraichtal (DE); Uwe Kögel, Kürnbach (DE); Joachim Haazendonk, Oberderdingen (DE)

(21) Appl. No.: 18/795,285

(22) Filed: Aug. 6, 2024

(30) Foreign Application Priority Data
Aug. 21, 2023 (DE) 10 2023 122 289.9

(51) Int. Cl. H02K 5/15; H02K 7/08; H02K 7/14

(52) U.S. Cl. CPC H02K 5/15; H02K 7/085; H02K 7/14

(57) ABSTRACT

A motor for a pump has a stator, a rotor with a front and a rear end, and a rotor bearing arrangement for the rotor, the rotor bearing arrangement having a rear bearing receptacle for the rear end of the rotor, and a motor cover on the rear bearing receptacle. The motor cover is connected form-lockingly with the rear bearing receptacle against movement in the axial direction of the motor away from the motor by way of a latching connection with latching projections on the bearing receptacle and elastic resilient latching arms on the motor cover, each of which interacts with one of the latching projections as a latching connection. The resilient latching arms are integrally connected to the motor cover in a region spaced by between 70% and 90% of the radial extent of the motor cover from the longitudinal center axis of the rotor, wherein they are elongate and are elastically movable in at least one direction.

### CROSS-REFERENCE TO RELATED APPLICATIONS

This application claims priority to German Application No. 10 2023 122 289.9, filed Aug. 21, 2023, the contents of which are hereby incorporated herein in its entirety by reference.

### AREA OF APPLICATION AND PRIOR ART

The invention relates to a motor or an electric motor, more specifically forming a structural unit with a pump or a pump part for liquid, i.e., a liquid pump. Furthermore, the invention relates to a pump with such a motor.

Such structural units comprising a motor or electric motor with a pump are known from the prior art, see for example US 2016/0169230 A1. In said prior art document, an electric motor forms a structural unit with a pump, wherein, for better integration, provision may be made for the motor to be not so much an independently handleable structural unit which could also be used in any desired other applications, but rather for a housing surrounding the motor or closing it to the outside to constitute an integral part of the overall structural unit.

### OBJECT AND ACHIEVEMENT THEREOF

The object of the present invention is that of providing a motor as mentioned above and a corresponding entire pump with such a motor which can solve the problems of the prior art and with which it is in particular possible to improve integration of the motor into a pump and achieve a more advantageous structure with simultaneous high motor functionality and safety.

This object is solved by a motor having the features of claim 1 and by a pump as a structural unit with such a motor having the features of claim 20. Advantageous and preferred embodiments of the invention are the subject matter of further claims and are explained in greater detail below. Some of the features are described only for the motor or only for the pump. Irrespective of this, they are however intended to be able apply by themselves and independently of one another, both to such a motor and to such a pump. The wording of the claims is incorporated into the content of the description by express reference.

The motor according to the invention has a stator, which in particular has a laminated stator core and stator windings on this laminated stator core. Furthermore, the motor has a rotor comprising a front end and a rear end and a longitudinal center axis which also corresponds to or defines the longitudinal center axis of the entire motor. The motor has a rotor bearing arrangement for this rotor. The rotor bearing arrangement in turn has a rear bearing receptacle for the rear end of the rotor, advantageously such that this rear bearing receptacle is provided wholly at the rear end of the rotor. The rear bearing receptacle may also overlap or cover the end of the rotor. A front bearing receptacle may also be provided for the front end of the rotor, but this is not of any relevance here. The motor has a motor cover in the region of the rear bearing receptacle, such that this motor cover as it were covers or closes the motor including the rear bearing receptacle to the rear or may form the rear end thereof. This motor cover is not necessarily in itself a load-bearing component, but rather closes the rear end of the motor against soiling; in doing so it may also assume further functions, as will be explained in greater detail below. The motor cover may engage over or cover not just the rear end of the motor as a type of rear end face but optionally also form at least one part of the outer periphery of the motor or engage thereover.

According to the invention, the motor cover is connected form-lockingly with at least the rear bearing receptacle, in particular is connected so as to be fastenable and undoable without use of a tool. This form-locking connection is advantageously configured such that the motor cover is secured thereby against movement in the axial direction of the motor away from the pump or away from a front end of the rotor. The form-locking connection may be in direct radially inward direction of the integral connection of the resilient latching arms to the motor cover. It is quite simply intended to fasten the motor cover firmly, but so as to be easily fastenable and undoable. In this way, sufficient stability and also covering of the rear end of the motor is advantageously provided, in particular also with sufficient ventilation through the motor cover. For this purpose, it may be provided with known ventilation openings. Said form-locking connection of the motor cover with the rear bearing receptacle is configured as a latching connection, specifically as a form-locking latching connection. To this end, latching projections are formed on the rear bearing receptacle. These latching projections are advantageously configured for latching retaining action along the longitudinal center axis, specifically away from the pump or away from the front bearing receptacle. The latching connection with the latching projections thus retains the motor cover on the motor. The motor cover may accordingly be secured in this direction.

Advantageously, at least two latching projections are formed on the bearing receptacle, such that at least two elongate, elastic resilient latching arms are formed on the motor cover, each of which interacts form-lockingly, by way of a latching end, i.e., a configuration of the end of the resilient latching arm provided for latching, with a respective latching projection of the rear bearing receptacle as a latching connection, or rests thereon. While the resilient latching arms thus preferably form the elastic or movable part of the latching connection with their latching ends, the latching projections on the rear bearing receptacle may form the stationary and in particular immobile and non-elastic or non-flexible part of this latching connection. When viewed in the radial direction, the resilient latching arms are here molded relatively far outward on the motor cover, in other words they are here integrally connected with the motor cover, in particular are produced in one piece and as one part therewith. In this case, they are connected to the motor cover in a region spaced by more than 50% of the radial extent of the motor cover from the longitudinal center axis of the rotor. This may under certain circumstances even be 70% or more, advantageously up to 90% of the radial extent of the motor cover. By attaching the resilient latching arms relatively far outward on the motor cover in this way, they may be as long as possible and thus as elastic as possible, even when made of a per se robust material. The elongate resilient latching arms are in this case elastically movable in at least one direction, wherein they may produce the latching connection by way of this movability, or the latching ends of the resilient latching arms may be deflected when brought up to the latching projections, such that they can then interact with these or engage behind them. Such movability of the resilient latching arms or of their latching ends can be achieved in various manners, as will be explained in detail below. They may either be movable in a direction parallel to the longitudinal center axis or at a right angle thereto or radially. Movability combining at least two of these movement options or movability directions is also possible.

The invention thus provides an option for fastening a motor cover according to the invention rapidly and simply and in particular without use of a tool to the remainder of the motor, specifically to the rear bearing receptacle, namely by way of a latching connection. At the same time, the motor cover can also be undone from the motor rapidly and advantageously without use of a tool.

In one configuration of the invention, all the resilient latching arms may be identically configured, which may also apply to the corresponding latching projections. They are particularly advantageously distributed regularly around the rear bearing receptacle in the circumferential direction. In this way, an even fastening action of the motor cover may be achieved. Three resilient latching arms may here be provided, which are then each arranged at 120° to one another.

The form-locking latching connections may be formed, in one configuration of the invention, in such a way that they take effect or are produced automatically when the motor cover is placed on or introduced at the rear onto the motor and the rear bearing receptacle. To this end, projections, centering aids or the like may be provided for precisely guided movement of the motor cover on the motor and/or on the rear bearing receptacle.

In one other configuration of the invention, provision is made for the latching connection to have to be produced separately even after introduction of the motor cover into its end position, in particular by pressing on or against the resilient latching arms. This will be explained below.

In one configuration of the invention, provision may be made for each resilient latching arm to extend substantially in one plane. Such a plane may extend parallel to the longitudinal center axis and/or the longitudinal center axis may lie in this plane. The movability of the resilient latching arm and thus also of the latching end is then provided substantially or at least also in a direction at angle to or at a right angle to the longitudinal center axis. The movability of the latching end in the radial direction or away from the longitudinal center axis and away from the latching projection is then provided merely indirectly by swiveling, but not by any movement precisely in the radial direction. The latching ends are then pushed away laterally, as it were, when viewed from the rear, to produce and also to undo the latching connection. To this end, per se known run-on bevels or the like may be provided, so that this takes place as it were automatically on production of the form-locking latching connection or is, in the case of manual production of the form-locking latching connection, at least facilitated. The advantage of such a configuration of the resilient latching arms resides in the fact that they may then extend to a degree parallel to the longitudinal center axis, whereby they may be very stable in this direction. They may then fasten the motor cover very firmly to the bearing receptacle or the latching connection may display a high retention force, in particular due to the specific configuration of the resilient latching arms per se. Here, the resilient latching arms are thus relatively thin in a circumferential direction and at the same time at least in part relatively wide in a direction parallel to the longitudinal center axis. In the widest region, their width may be between five times and twenty times as great as their thickness. In the narrowest region, in particular on or close to the latching end, the width may correspond to the thickness or be up to four times the thickness.

In another alternative configuration of the invention, the resilient latching arms are movable parallel to the longitudinal center axis due to their structural configuration, in particular their latching ends are also movable in a purely radial direction. To this end, they may be configured to be relatively immovable or stable in a direction at right angles to the longitudinal center axis and at a right angle to their own longitudinal extent, i.e., as it were in a lateral direction. These resilient latching arms may be bent at least once, from their integral connection with the motor cover, which, as described above, is advantageously relatively far outward, up to their free end on which the latching end is arranged. They are advantageously bent twice or three times. Preferably, repeated bends are formed, bending in each case in opposite direction, i.e., as it were a simple S-shape or a double S-shape. Such S-shaped or repeated bends enable the latching ends to be movable solely in the radial direction and thus to be moved away from the latching projections on the rear bearing receptacle on production of the latching connection and also when the latter is undone. Furthermore, the resilient latching arms may here protrude less far from a plane of the motor cover running at right angles to the longitudinal center axis and as it were substantially covering the rear end of the motor. In this way, the structural height along the longitudinal center axis may possibly be less than in the above-stated alternative configuration of the invention.

In one advantageous further development of the invention, to facilitate production of the latching connection a bevel is provided at the free end of the resilient latching arms, which bevel forms a latching end of the resilient latching arm. This bevel makes it easier for the end of the resilient latching arm to deflect away from the latching projection on the rear bearing receptacle, and to thus produce the latching connection automatically when the motor cover is introduced onto the motor or from the rear onto the rear bearing receptacle. The resilient latching arm thus does not expressly need to be moved deliberately to the side, thereby facilitating the assembly process. Such a bevel may point away from the longitudinal center axis in a direction from the rear bearing receptacle toward a front bearing receptacle of the rotor or it may point toward the introduced motor cover. A similar, corresponding bevel may advantageously be provided on the latching projection on the rear bearing receptacle, such that the two bevels interact on deflection of the latching end of the resilient latching arm.

In one advantageous further development of the invention, each resilient latching arm may reduce in width from its connection with the motor cover to the free end with the latching end. This on the one hand enables a certain material saving to be made. On the other hand, the movability or bendability of the resilient latching arm may in this way be influenced or adjusted in a way considered advantageous both for production of the latching connection and above all for retention of the motor cover on the motor. This change or reduction in width may be such that, in the second above-stated configuration of the invention, the two side edges of the resilient latching arm extend roughly in the radial direction and point toward the longitudinal center axis. Due to the resilient latching arm having a smaller width close to the end thereof, there also remains sufficient space in the central region of the motor cover for the integral connection to be retained, so that the motor cover is stable also in this region. In this region, provision may also be made for the motor cover to rest at the rear directly on the bearing receptacle for greater overall stability, i.e., it is not only connected with the rear bearing receptacle by the latching connection itself.

In the first above-stated alternative regarding the configuration of the resilient latching arms, which extend as it were in a plane through which the longitudinal center axis runs, the reduction in the width from radially outward to radially inward may serve the purpose that more structural space is conventionally present in the radially outer region than in the radially inner region. The reason for this is primarily that the rear bearing receptacle conventionally forms the rearmost region of the motor, and further extension of the structural length of the motor in this direction would be undesirable. In this way, the available structural space is in each case well utilized to configure the resilient latching arm to be as stable as possible along the longitudinal center axis, since the resilient latching arms are intended to hold the motor cover as firmly as possible on the motor through the latching connection in precisely this direction.

Provision may in general be made for a reduction in the width of the resilient latching arms to be roughly uniform, in particular for the width to decrease constantly or constantly strictly monotonically.

In one advantageous further development of the invention, provision may be made for a protruding projection to be formed on each free end of each resilient latching arm, which projection projects outward or rearward and may serve as a manual handle for manually undoing the latching connection. The latching connection may thus be rapidly undone, and moreover not even a simple tool such as for example a screwdriver is needed. Such a projection may protrude from the resilient latching arm roughly parallel to the longitudinal center axis and/or extend roughly at a right angle to the direction in which the latching end is moved to undo the latching connection.

One configuration of the latching projections on the bearing receptacle may be such that they protrude radially by a length of between 1% and 20%, in particular up to 10%, of the diameter of the rear bearing receptacle. This enables not only a stable latching connection but, at the same time, a size of the latching projections that is not very troublesome. If it may advantageously be ensured that the resilient latching arms, in particular in the second above-stated alternative configuration with multiple bends over their profile, apply pressure radially toward the longitudinal center axis, they may make it more difficult for the latching connection to come undone spontaneously. As a result, the overlap of latching projection and latching end of the resilient latching arm does not have to be so large to prevent this.

In one further advantageous configuration of the invention, provision may be made for at least one retaining peg, advantageously at least two retaining pegs, to protrude from the motor cover. This retaining peg points from the motor cover toward the front end of the rotor and extends roughly or precisely parallel to the longitudinal center axis. These retaining pegs may serve to prevent the motor cover from rotating about the longitudinal center axis or from shifting at a right angle thereto. This may furthermore ensure that the motor cover can only be moved out of the end position in the common structural unit along the longitudinal center axis away from the motor, and it is then sufficient for the latching connection alone to prevent this. Such a retaining peg or advantageously all the retaining pegs may engage in a recess in the stator, in particular as holes in the laminated stator core. Furthermore, the length of at least one retaining peg may be configured such that the retaining pegs firstly engage in the recesses and only then is the latching connection produced or only then do the latching ends of the resilient latching arms move onto the latching projections or come into contact with the latter, possibly also the respective bevels. The great advantage of this is that then precisely guided movement of the motor cover relative to the motor is or has been brought about when the latching connection is produced, so bringing about or facilitating precise production thereof as specified. Such retaining pegs and the respective corresponding recesses may be provided with insertion bevels or the like or be of conical configuration for easier insertion. This is known from the prior art relating to centering pegs or the like.

In one advantageous configuration of the invention, the motor cover completely covers the rear bearing receptacle. Furthermore, it covers the rear axial end of the motor. It advantageously engages over the motor or a part of the stator or the laminated stator core thereof with the stator windings toward the outside. One option is for it to engage completely thereover, such that electrical insulation is achieved to the best possible degree. Alternatively, it may leave at least half, advantageously up to 80% or up to 90%, of the laminated stator core outwardly exposed. Cooling thereof by ambient air may then be improved, so as to reduce or prevent overheating of the motor during operation.

In one possible further development of the invention, it may be provided, in particular in the second alternative of resilient latching arm configuration, that although the motor cover moves into the end position when introduced from the rear, in particular also by the above-described advantageous retaining pegs engaging in recesses in the stator, the latching connections are not as yet or not as yet completely produced. They have then additionally to be produced manually by pressing on the resilient latching arms, in particular in the region of their latching ends, in the axial and/or radial direction of the rotor. This of course requires somewhat more effort when assembling the motor, but at the same time a configuration or strength of the resilient latching arms may then be improved as the case maybe.

As an alternative to a configuration of the above-stated retaining pegs where they engage in recesses in the stator, an outer edge of the motor cover may also engage completely over the stator in such a way that this is only possible in a single, precisely defined position. This also results in anti-rotation securing, for example in the case of a generally roughly rectangular or square outer stator shape.

A resilient latching arm may be configured such that, starting from its integral connection with the motor cover, it firstly extends in a precisely radial direction, then bends in a bend, in particular of around 90°, toward the front end of the rotor, wherein it is then bent in a further bend, in particular again of about 90° and with a wide radius, toward the longitudinal center axis. In a further configuration, after the last bend the resilient latching arm may again be bent round by around 90°, so it then points in a direction roughly parallel to the longitudinal center axis and away from the rotor. The latching end on the resilient latching arm may be arranged adjacent thereto, preferably again with a bend of about 90° toward the longitudinal center axis, such that the latching end points toward the longitudinal center axis, preferably points roughly at right angles thereto. The latching end thus points in the same direction as the start of the profile of the resilient latching arm at the point of connection with the motor cover, with a broadly curved bend therebetween, advantageously into the motor or toward the front end of the rotor. This bent profile brings about the movability or bendability according to the invention of the resilient latching arm.

In a further configuration of the invention, the resilient latching arms may be configured such that, in a basic position where the motor cover has not been placed onto the motor and the resilient latching arms have not been force-loaded or snapped on, there is a distance between the latching ends and the latching projections which points away in the direction of the longitudinal center axis. Such a distance may preferably amount to 0.2 cm to 2 cm or 2% to 30% of the length of the resilient latching arms. In this configuration of the motor cover, once the motor cover has been placed onto the rear end of the motor, each latching connection does have to be produced, preferably by pressing manually on the resilient latching arms, in particular in the region of the latching ends, possibly by pressing on the previously described protruding projections. It may thus however be ensured that the resilient latching arms retain the motor cover on the motor with preloading and thus with a significant retention force.

The pump according to the invention has a pump part and a previously described motor, wherein the motor is arranged on and fastened to the pump part in such a way that the motor and the pump part form the pump as a structural unit. The motor here forms the drive for the pump part or for a impeller provided therein in the case of a configuration of the pump as an impeller pump.

These and further features are revealed in the description and in the drawings as well as in the claims, wherein the individual features can each be realized singly or severally in the form of sub-combinations in one embodiment of the invention and in other fields, and can represent embodiments advantageous and protectable per se, for which protection is claimed here. The subdivision of the application into individual sections and sub-headings does not limit the general validity of the statements made thereunder.

### BRIEF DESCRIPTION OF THE DRAWINGS

Exemplary embodiments of the invention are shown schematically in the drawings and are explained in more detail below. In the drawings:

FIG. 1 is an oblique view of a structural unit with a pump part and a motor according to the invention as a pump according to the invention,

FIG. 2 is a rear view of the pump with the motor and a motor cover,

FIG. 3 is a section through the motor according to the invention with motor cover,

FIG. 4 shows a further section through the motor cover from the perspective of FIG. 3,

FIG. 5 is a rear view of an alternative motor cover with differently configured resilient latching arms,

FIG. 6 shows an enlarged portion of FIG. 5 showing movement of one of the resilient latching arms,

FIG. 7 is a lateral sectional representation through the motor cover of FIG. 5, and

FIG. 8 is a further representation of movement of the resilient latching arm.

### DETAILED DESCRIPTION OF THE EXAMPLES

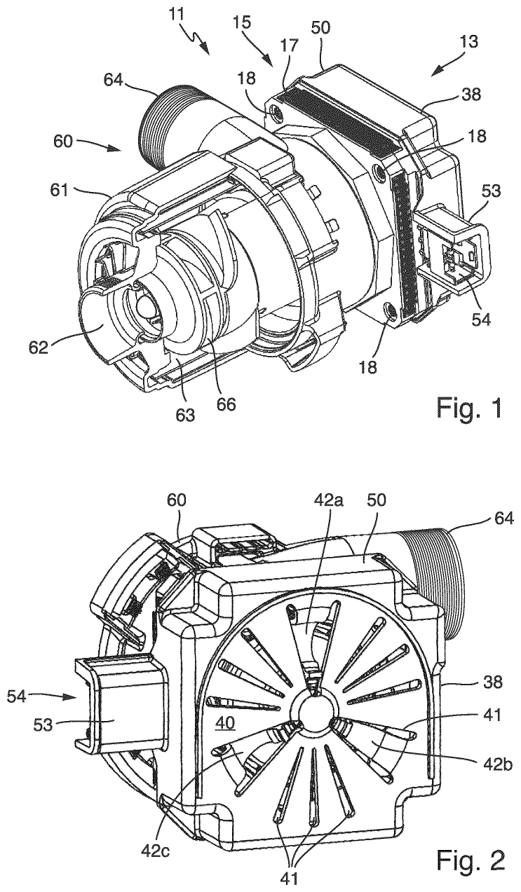

FIG. 1 shows a pump 11 according to the invention as a structural unit with a motor 13 which is mounted to a pump part 60 at the rear such that the two form the structural unit 11. The pump part 60 is configured substantially as known from the prior art, for example from the above-stated US 2016/0169230 A1. It has a pump housing 61 with an inlet 62 into a pump chamber 63. An impeller 66 rotates therein and delivers the water through the pump chamber 63 as far as to an outlet 64. The pump is therefore an impeller pump. A heating element may be provided in the pump chamber 63, but this is of no significance here.

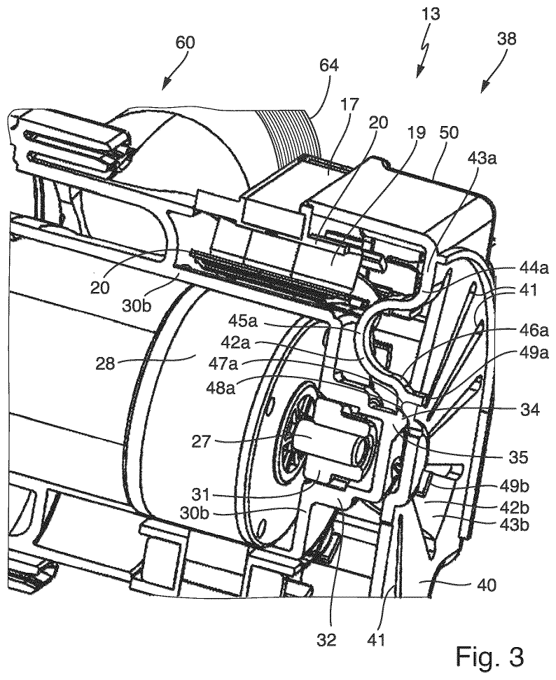

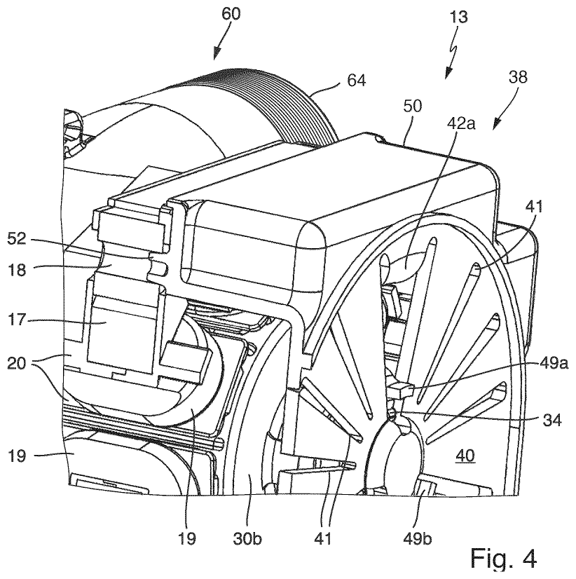

The motor 13 has a stator 15 with a laminated stator core 17, see also the enlarged depictions of FIGS. 3 and 4. In the substantially square laminated stator core 17 with beveled corners, retaining recesses 18 in the form of through-holes or -bores are provided in the corner regions, whose function will be explained in greater detail below. FIGS. 3 and 4 show the stator windings 19 attached to winding holders 20. These winding holders 20 are in turn connected to the laminated stator core 17. The stator windings 19 are arranged relatively close around a housing 30b of the motor 13.

A rotor 28 with a through rotor shaft is arranged in the housing 30b. The rotor shaft has a rear shaft end 27, which is arranged in a rear bearing receptacle 30a by way of a bearing 31. The rear bearing receptacle 30a is part of the housing 30b. It may be approximately cup-shaped with a rear receiving cup 32. Three latching projections 34, as described above, are provided distributed regularly circumferentially around the receiving cup 32. The latching projections 34 have rearward and obliquely radially outward bevels 35. To the front they are flattened in the radial direction, to achieve the best possible latching action.

A flat motor cover 38 is placed from the rear onto the motor 13 and thus overlaps the rear side thereof or forms the latter. The motor cover 38 thus consists of a rear side 40, which extends substantially in a plane perpendicular to the longitudinal center axis of the rotor 28. Furthermore, the motor cover 38 has an external frame 50 or the rear side 40 merges directly into the external frame 50. According to FIG. 2, this external frame 50 extends in a roughly square shape with notches in the corner regions and overlaps with the part of the stator windings 19 which projects toward the rear below the laminated stator core 17. Furthermore, the external frame 50 also engages with a front edge by a small amount over the laminated stator core 17. Retaining pegs 52 of the motor cover 38 molded on in accordance with FIG. 4 engage in the above-stated retaining recesses 18. Insertion is facilitated by the depicted conical configuration of the retaining pegs 52. This ensures precise positioning and above all anti-rotation securing and also securing against any shift in the direction at right angles to the longitudinal center axis of the rotor 28. This may additionally or alternatively also be achieved by the front edge of the external frame 50 engaging over the laminated stator core 17 or the winding holder 20.

According to FIG. 1, a socket housing 53 is molded onto the motor cover 38 or onto the external frame 50, in which a socket 54 is provided for electrical connection of the motor 13 or of the entire structural unit 11. If the pump 60 has the above-stated heating element, electrical connection thereof may advantageously also proceed by way of the socket 54.

While the retaining pegs 52 in the retaining recesses 18 of the laminated stator core 17 prevent the motor cover 38 from twisting or shifting on the motor 13, the form-locking latching connection according to the invention is still required in order to prevent removal of the motor cover 38 away from the motor along the longitudinal center axis. To this end, the motor cover 38 has three resilient latching arms 42a, 42b and 42c on the rear side 40. These are separated from one another by respective ventilation slots 41. It is clear from FIG. 2 that both the resilient latching arms 42a to 42c and the ventilation slots 41 extend or are configured as it were precisely in the radial direction. The sectional representation in FIG. 3 shows that the resilient latching arm 42a is connected in a connection region 43a with the motor cover 38 or the rear side 40. The parts are produced integrally in a single plastics injection molding operation. Starting from the connection region 43a, the resilient latching arm 42a is bent forward in a first bend 44a of around 80° with a somewhat greater bend. Directly after this first bend 44a the resilient latching arm 42a is bent in the opposite direction by a second bend 45a, specifically around twice as far, i.e., around 160°. The first bend 44a and second bend 45a are advantageously regular.

Directly after this second bend 45a, the resilient latching arm 42a is again bent in the opposite direction in a third bend 46a of around 80°, advantageously of somewhat less than the first bend 44a. A latching end 47a of the resilient latching arm 42a following the third bend 46a then, although relatively short, advantageously points once again in the radial direction. An extension thereof should here point precisely toward the longitudinal center axis of the rotor 28.

The latching end 47a has a bevel 48a pointing downward and to the left, for example with an angle of around 45° to the longitudinal center axis. The angle of this bevel 48 should be roughly parallel to the angle of the bevel 35 of the latching projection 34. The latching end 47 engages behind the latching projection 34, so producing the latching connection. On production of this latching connection, the latching end 47a may slide readily with its bevel 48a along the bevel 35 of the latching projection 34, as is fundamentally known for latching connections. In the process, the latching end 47a deflects radially away from the latching projection 34 due to the elasticity of the resilient latching arm 42a, until it is able to engage behind said latching projection 34.

To produce the latching connection, an axially protruding projection 49a, which may have a length of 0.5 cm to 1 cm, is molded on shortly before the latching end 47a. By applying pressure to this projection 49a in the axial and radial directions, the latching end 47a may in any case be securely introduced behind the latching projection 34. It is apparent from FIG. 3 that the resilient latching arm 42a has a degree of axial movability regarding its latching end 47a, due to its extending overall in the radial direction and being produced from appropriately elastic, but at the same time robust plastics material. In this direction, the resilient latching arm 42a is, however, intended simultaneously to hold the motor cover 38 on the motor 13 and secure it against removal.

The repeatedly bent configuration of the resilient latching arm 42a, with its three bends 44a, 45a and 46a, provides a degree of elasticity in the radial direction, which is required to ensure that the latching end 47a can be moved somewhat in the radial direction on production of the latching connection in order then to engage behind the latching projection 34. This movability or bendability in the radial direction to produce the latching connection does not per se impair the retaining action in the axial direction, although naturally the resilient latching arm 42a is somewhat less rigid as a whole as a result.

By providing three resilient latching arms 42a, 42b and 42c, an overall sufficiently great retention force can be achieved for retaining the motor cover 38 on the motor 13. The precise configuration of the resilient latching arms 42a to 42c is also significant here.

Provision may moreover be made for the resilient latching arms 42a to 42c to be configured, in a simple configuration, in such a way that the latching connection is automatically produced when the motor cover 38 is slid onto the motor 13 from behind, the retaining pegs 52 engaging in the retaining recesses 18. The latching ends 47 of the resilient latching arms 42 thus engage automatically and independently behind the respective latching projections 34 on the receiving cup 32. It is then impossible, however, for the resilient latching arms 42a to 42c to be preloaded in the position or end position of the resultant latching connection in such a way that they press the motor cover 38 still more firmly against the motor 13 through their own preloading. If this is desired, the resilient latching arms 42a to 42c may be configured such that, in the end position of the motor cover 38 on the motor 13 according to FIG. 4, they still do not engage with their latching ends 47 behind the latching projections 34. They may either rest thereagainst or even be spaced a little therefrom axially when said resilient latching arms 42 are in a basic position. Then, by pressing against the projections 49 in the axial and somewhat in the radial outward direction, each resilient latching arm 42 is moved toward the front end of the motor and thus, in particular with the assistance of the bevels 48 and 35, the respective latching end 47 is pushed behind the projection 34. In the process, the resilient latching arms 42 are preloaded or receive preloading which then, as a permanent force, pushes the motor cover 38 against the motor 13. In this way, a stable, reliable and durable connection is achieved. Unlike with an automatically produced latching connection, on introducing the motor cover 38 from the rear onto the motor 13, a degree of assembly effort is then needed, either using automated equipment or manually, specifically by applying appropriate pressure against the projections 49. This effort is not very great, however, and cannot be performed incorrectly. Furthermore, the preloading on the resilient latching arms 42 achieved in this way may bring about very stable fastening of the motor cover 38 to the motor 13.

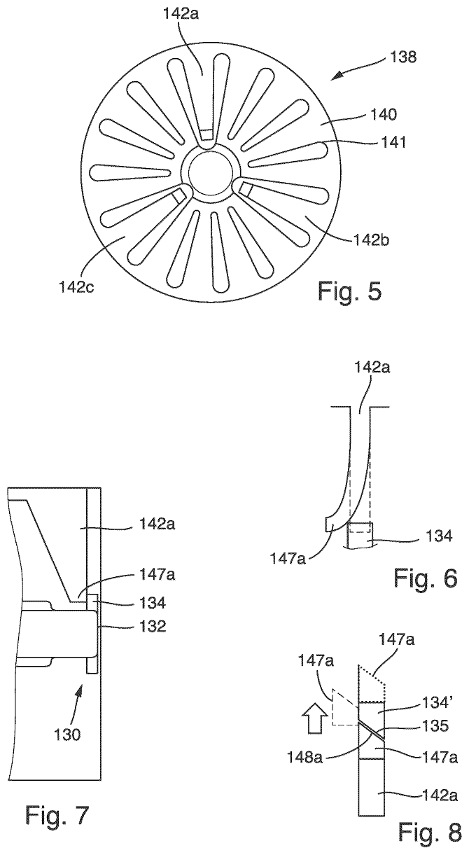

An alternative second exemplary embodiment for the resilient latching arms is shown in FIGS. 5 to 7. The rear view of the motor cover 138 with the rear side 140 according to FIG. 5 shows that, here too, ventilation slots 141 are on the one hand provided in the radial direction. Three resilient latching arms 142a, 142b and 142c are moreover provided, which are each of identical configuration. These resilient latching arms, which are shown in side view in FIG. 7, have a thickness which advantageously corresponds to the material thickness of the remainder of the motor cover 138. However, they are wider, as it were, as shown in FIG. 7. In particular, compared to the resilient latching arms 42 of FIGS. 1 to 4 they are, as it were, rotated by 90° and do not have any bends but rather extend completely straight. A comparison of FIGS. 5 and 7 shows that these resilient latching arms 142a to 142c are radially not at all movable or bendable. Furthermore, they are likewise barely bendable or movable in the axial direction, as here their large width lends significant axial stability. It is therefore also apparent from FIG. 7 that the form-locking latching connection therein, with which a latching end 147a of the resilient latching arm 142a engages behind the latching projection 134 on the receiving cup 132 of the rear bearing receptacle 130, cannot be achieved as described for the first configuration. In this respect, the enlarged rear view of FIG. 6 shows schematically that the resilient latching arms 142a to 142c are movable or bendable in a transverse direction relative to their longitudinal extent, which runs at right angles to the longitudinal center axis. The solid lines in FIG. 6 show how the resilient latching arm 142a is bent sideways to the left when the motor cover 138 is introduced from the rear onto the motor. In the process, the latching end 147a is bent so far to the left that it moves laterally past the latching projection 134. In the end position according to FIG. 7, the resilient latching arm 142a is then bent back into its basic position, which is shown in dashed lines in FIG. 6, with it then engaging with its latching end 147a behind the latching projection 134.

Since this deflection movement of the resilient latching arm 142a cannot be achieved with the same bevels as in the first exemplary embodiment, one option is to provide for the end of the resilient latching arm 142a to be bent sideways when the motor cover 138 is introduced using similar projections to the projections 49 of the first exemplary embodiment. Manual assembly is then advantageously needed, with the form-locking latching connections being individually produced in each case. In this case, provision may advantageously be made for retaining pegs of the motor cover 138 already to engage in retaining recesses 18 of the laminated stator core 17, so as to prevent the motor cover 138 from rotating relative to the motor.

Alternatively, bevels may in turn be provided in order to bring about the deflection movement of the end region of the resilient latching arm 142a shown in FIG. 6 when the axial movement occurs, the bevels then being configurable as shown in FIG. 8. This is a view from the longitudinal center axis towards the radial direction and shows on the one hand the projection 134 with a bevel 135 and on the other hand the resilient latching arm 142a with a bevel 148a. The resilient latching arm 142a is introduced in the axial direction of movement per the arrow, and brings about a deflection movement of the end region of the resilient latching arm 142a by the bevels 135 on the one hand and 148a on the other sliding against one another. In the deflected position shown by dashed lines, the resilient latching arm 142a or the latching end 147a thereof may then be moved laterally past the projection 134 in the axial direction. As it moves past, it may spring back there behind into the basic position shown by dotted lines, where it rests form-lockingly against the opposite side of the latching projection 134 from the bevel 135.

It is clear that this second exemplary embodiment is able to achieve greater force absorption in the axial direction or a stronger latching connection in the axial direction. At the same time, however, it may be that the assembly effort is increased somewhat.

1. A motor, said motor having:
a stator,
a rotor with a front end and a rear end,
a rotor bearing arrangement for said rotor, said rotor bearing arrangement having a rear bearing receptacle for said rear end of said rotor, and
a motor cover in a region of said rear bearing receptacle,
wherein
said motor cover is connected form-lockingly at a form-locking connection with at least said rear bearing receptacle to make a form-locking connection, wherein said form-locking connection is such that said motor cover is secured against movement in an axial direction of said motor away from said motor,
said form-locking connection is configured as a form-locking latching connection with latching projections on said bearing receptacle,
at least two elastic resilient latching arms are formed on said motor cover, each of which interacts by way of a latching end with one of said latching projections as a latching connection,
said elastic resilient latching arms are integrally connected to said motor cover in a region spaced by more than 50% of a radial extent of said motor cover from said longitudinal center axis of said rotor,
said elastic resilient latching arms are elongate and are elastically movable in at least one direction.

2. The motor as claimed in claim 1, wherein said motor is configured as a structural unit with a pump for liquid, in a form of a liquid pump.

3. The motor as claimed in claim 1, wherein said resilient latching arms are all identically configured.

4. The motor as claimed in claim 1, wherein each of said resilient latching arms extends substantially in one plane.

5. The motor as claimed in claim 1, wherein each resilient latching arm, from its integral connection with said motor cover up to a free end with said latching end, is bent at least once.

6. The motor as claimed in claim 5, wherein each resilient latching arm, from its integral connection with said motor cover up to a free end with said latching end, with in each case opposing bends in a form of an S, is bent twice or three times with two or three bends.

7. The motor as claimed in claim 5, wherein said bends give said free end of said resilient latching arm elastic movability and bendability parallel to a longitudinal center axis and elastic movability and bendability in a radial direction.

8. The motor as claimed in claim 1, wherein a bevel is provided as a latching end at said free end of said resilient latching arm, wherein said bevel points away from said longitudinal center axis in a direction from said rear bearing receptacle toward a front bearing receptacle.

9. The motor as claimed in claim 1, wherein each resilient latching arm reduces in width from its integral connection with said motor cover to said free end.

10. The motor as claimed in claim 1, wherein a protruding projection is formed at said free end of each resilient latching arm, which projection protrudes rearward as a manual handle for manually undoing said latching connection.

11. The motor as claimed in claim 1, wherein said latching projections protrude radially from said bearing receptacle by a length of between 1% and at most 20% of a diameter of said rear bearing receptacle.

12. The motor as claimed in claim 1, wherein at least two retaining pegs protrude from said motor cover toward said front end of said rotor parallel to said longitudinal center axis, wherein said retaining pegs engage in recesses in said stator as anti-rotation securing for said motor cover about said longitudinal center axis.

13. The motor as claimed in claim 1, characterized in that said resilient latching arms extend substantially in a radial direction toward said longitudinal center axis.

14. The motor as claimed in claim 1, wherein, starting from their integral connection with said motor cover, said resilient latching arms firstly extend in a radial direction, then bend in a bend toward said front end of said rotor, wherein they are then bent in a further bend toward said longitudinal center axis.

15. The motor as claimed in claim 14, wherein said bends amount to around 90° and are formed with a wide radius.

16. The motor as claimed in claim 14, wherein, after said last bend, said resilient latching arms are again bent round by around 90°, such that they then point in a direction roughly parallel to said longitudinal center axis and away from said rotor, wherein said latching end on said resilient latching arm is then arranged adjacent thereto.

17. The motor as claimed in claim 16, wherein said latching end is arranged on said resilient latching arm, and again points with a bend of about 90° toward said longitudinal center axis such that said latching end points toward said longitudinal center axis.

18. The motor as claimed in claim 1, wherein said resilient latching arm is configured such that, in a basic position where said motor cover has not been placed onto said motor and said resilient latching arm has not been force-loaded or snapped onto said latching connection, there is a distance provided between said latching end and said latching projection which points away in a direction of said longitudinal center axis.

19. The motor as claimed in claim 18, wherein said distance amounts to 0.2 cm to 2 cm or 2% to 30% of a length of said resilient latching arm.

20. The motor as claimed in claim 1, wherein said form-locking connection is in direct radially inward direction of said integral connection of said resilient latching arms to said motor cover.

21. A pump with a pump part and with a motor as claimed in claim 1, wherein said motor is arranged on said pump part such that motor and pump part form said pump as a structural unit.
